(19) United States
(12) Patent Application Publication
(10) Pub. No.: US 2026/0355920 A1
(43) Pub. Date: Nov. 12, 2026

(54) POWER TOOL WITH A LOCK-ON SWITCH

(71) Applicant: Techtronic Cordless GP, Anderson, SC (US)

(72) Inventors: Jin Hua GAO, Dongguan City (CN); Shi Chun LIU, Dongguan City (CN)

(21) Appl. No.: 19/670,296

(22) Filed: May 7, 2026

(30) Foreign Application Priority Data
May 9, 2025 (HK) 22025107061.5

(51) Int. Cl. B25D 17/04; B25D 16/00

(52) U.S. Cl. CPC B25D 17/04; B25D 16/006; B25D 2250/261; B25D 2250/265

(57) ABSTRACT

A power tool features a motor, working output, drive transmission for multiple operation modes, main trigger, mode change switch, and lock-on switch. The control unit detects the main trigger's actuation status. When the main trigger is on, the tool operates in one of at least two modes. It monitors the current mode and lock-on switch status. If the tool is in the first mode and the lock-on switch is active, it stays in that mode until the lock-on switch is inactive and the trigger is off. In the second mode, the tool operates regardless of the lock-on switch status and continues until the main trigger is turned off.

### CROSS-REFERENCE TO RELATED APPLICATIONS

This application claims priority under the Paris Convention to Hong Kong Patent Application No. 22025107061.5 filed on May 9, 2025, the entire content of which is incorporated herein by reference.

### FIELD OF THE DISCLOSURE

The present disclosure relates to a power tool and, in particular, a power tool with a lock-on switch.

### BACKGROUND OF THE DISCLOSURE

Many power tools include a lock-on function to save user fatigue. When operating the power tool, the lock-on function may be activated by the user. The user may then release the main trigger of the power tool, and the tool will continue to operate. The lock-on function, which is generally a mechanical block on the trigger, will maintain the tool in an activated state until it is released.

This can reduce fatigue for the user caused by holding the main trigger for a long time. However, certain tools are not suitable for a lock-on mode as it would be unsafe to have the tool activated without user input.

### SUMMARY OF THE DISCLOSURE

Features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims.

In accordance with one aspect of the present disclosure, there is provided a power tool comprising a motor; a working output; a drive transmission arranged to receive a power output of the motor and drive the working output to operate in one of a plurality of operation modes; a main trigger; a mode change switch configured to switch the drive transmission between the at least two operation modes; a lock-on switch configured to move between an active status position and an inactivate status position; a control unit configured to detect an actuation status of a main trigger of the power tool; in response to detecting that the actuation status of the main trigger is turned on, operate the power tool in one of at least two operation modes; detect the current operation mode and a status of a lock-on switch of the power tool; in response to detecting a first operation mode and an active status of the lock-on switch, operate the power tool in the first operation mode until the status of the lock-on switch is inactive and the actuation status of the main trigger is turned off; in response to detecting a second operation mode, regardless of the detected status of the lock-on switch, operate the power tool in the second operation mode until the actuation status of the main trigger is turned off.

The plurality of operation modes may include at least one of an impacting mode, a drilling mode and a hammer drill mode.

The impacting mode may allow the working output to reciprocate along a central axis of the working output.

The drilling mode may allow the working output to rotate about a central axis of the working output.

The hammer drill mode may allow the working output to perform both reciprocating and rotary actions simultaneously.

The first mode may be the impacting mode and the second operation mode may be the drilling mode.

The first mode may be the impacting mode and the second operation mode may be the hammer drill mode.

The motor may be a brushless DC motor.

The main trigger may include at least one of an electrical contact switch, a microswitch, a Hall effect switch and a linear or rotary potentiometer.

The lock-on switch may include at least one of an electrical contact switch, a microswitch, a Hall effect switch and a linear or rotary potentiometer.

The control mechanism of the lock-on switch may include at least one of push-and-hold control, push-on/push-off control, rotary control and slide control.

The lock-on switch may be coupled with a mechanical locking element such that moving the lock-on switch to the active status position causes the mechanical locking element to move into a blocking position configured to hold the main trigger in a turned-on actuation status.

The control unit may be configured to, in response to a second operation mode, deactivate the power tool in response to detecting an active status of the lock-on switch.

The power tool may include at least one of a hammer drill, an impact driver, a drill driver, a chainsaw, a circular saw, a jigsaw and a blower.

In accordance with another aspect of the present disclosure, there is provided a method of operating a power tool, the steps comprising detecting the actuation status of a main trigger of the power tool; in response to detecting that the actuation status of the main trigger is turned on, operating the power tool in one of at least two operation modes; detecting the current operation mode and a status of a lock-on switch of the power tool; in response to detecting a first operation mode and an active status of the lock-on switch, operating the power tool in the first operation mode until the lock-on switch is turned off and the actuation status of the main trigger is turned off; in response to a second operation mode, regardless of the detected status of the lock-on switch, operating the power tool in the second operation mode until the actuation status of the main trigger is turned off.

The operation modes may include at least one of an impacting mode, a drilling mode and a hammer drill mode.

The impacting mode may allow the working output to reciprocate along a central axis of the working output.

The drilling mode may allow the working output to rotate about a central axis of the working output.

The hammer drill mode may allow the working output to perform both reciprocating and rotary actions simultaneously.

The first mode may be the impacting mode and the second operation mode may be the drilling mode.

The first mode may be the impacting mode and the second operation mode may be the hammer drill mode.

The method may include, in response to a second operation mode, deactivating the power tool in response to detecting an active status of the lock-on switch, wherein the lock-on switch may be coupled with a mechanical locking element such that moving the lock-on switch to the active status position causes the mechanical locking element to move into a blocking position configured to hold the main trigger in a turned-on actuation status.

In accordance with another aspect of the present disclosure, a power tool includes a motor, a working output, a drive transmission arranged to receive a power output of the motor and drive the working output to operate in one of a plurality of operation modes, a main trigger, a mode change switch configured to switch the drive transmission between the plurality of operation modes, and a lock-on switch configured to move between an active status position and an inactive status position. The lock-on switch includes a lock housing, a lock body disposed inside the lock housing and rotatable relative to the lock housing, a locking pin selectively engageable with the main trigger, a tactile switch, and a locking spring configured to actuate the tactile switch. When the lock body is rotated to a first position, the locking pin is not engaged with the main trigger and the lock-on switch is in the inactive status position. When the lock body is rotated to a second position, the locking pin is engaged with the main trigger and the lock on switch is in the active status position.

In some embodiments, when the lock body is rotated to the first position, the locking spring does not actuate the tactile switch.

In some embodiments, when the lock body is rotated to the second position, the locking spring actuates the tactile switch.

In some embodiments, the main trigger is configured to move between a released position and engaged position. When the lock-on switch is in the active position with the main trigger in the released position, the main trigger is locked in the released position.

In some embodiments, the power tool further comprises a control unit configured to detect the position of the lock-on switch, the main trigger, and the mode change switch.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended figures. Understanding that these figures depict only exemplary embodiments of the disclosure and are not therefore to be considered to be limiting of its scope, the principles herein are described and explained with additional specificity and detail through the use of the accompanying figures.

Preferred embodiments of the present disclosure will be explained in further detail below by way of examples and with reference to the accompanying figures, in which:

FIG. 1 shows a schematic diagram of a power tool according to an embodiment.

FIG. 2 shows a partial section view of a power tool according to a first embodiment.

FIG. 3 shows a partial section view of a power tool according to a first embodiment.

FIG. 4 shows a partial section view of a power tool according to a first embodiment.

FIG. 5 shows an exemplary process of operating a power tool according to an embodiment.

FIG. 6 shows a partial section view of a power tool according to a first embodiment.

FIG. 7 shows a partial section view of a power tool according to a second embodiment.

FIG. 8 shows a partial section view of a power tool according to a second embodiment.

FIG. 9 shows a partial section view of a power tool according to a second embodiment.

FIG. 10 shows a partial section view of a power tool according to a second embodiment.

FIG. 11 shows a partial section view of a power tool according to a third embodiment.

FIG. 12 shows a partial section view of a power tool according to a third embodiment.

FIG. 13 shows a partial section view of a power tool according to a fourth embodiment.

FIG. 14 shows a partial section view of a power tool according to an alternative fourth embodiment.

FIG. 15 shows an exposed view of the lock body according to a fourth embodiment.

FIG. 16 shows a partial section view of the lock body and the surrounding lock housing, according to a fourth embodiment.

FIG. 17 shows a partial section view of a power tool according to a fourth embodiment.

FIG. 18 shows an external view of a power tool according to an embodiment.

FIG. 19 shows a partial section view of a power tool according to an embodiment.

FIG. 20 shows a partial section view of a power tool according to an embodiment.

FIG. 21 shows a flowchart representing a method of operating a power tool according to an embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without departing from the scope of the disclosure.

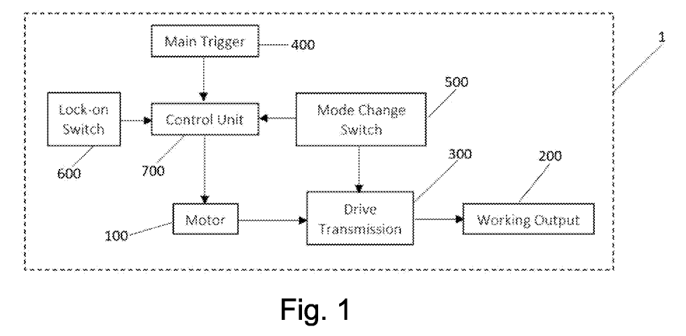

Referring to the drawings, there is shown in FIG. 1 a schematic diagram of a power tool 1 according to an embodiment. The power tool 1 comprises a motor 100, a working output 200, a drive transmission 300, a main trigger 400, a mode change switch 500, a lock-on switch 600 and a control unit 700.

The motor 100 may be any suitable electric motor 100. For example, the motor 100 may be an AC motor or a DC motor. The motor 100 may be a brushed or brushless DC motor. The motor 100 may have any suitable voltage rating e.g. in a range of approximately 12 Volts to approximately 60 Volts, as required for the purpose of the power tool 1.

The working output 200 may include a rotating and/or reciprocating output. The working output 200 may be driven directly or indirectly by the motor 100. The working output 200 may include a working component. For example, the working component may include a bit, socket, blade, disc or any other suitable working component. The working output 200 may be integrated with the working component or may be connected to a separate working component.

The drive transmission 300 is arranged to receive a power output of the motor 100. The drive transmission 300 may include one or more step down and/or step up gear pairings. The drive transmission 300 may include one or more planetary gear arrangements. The drive transmission 300 may include one or more modification mechanisms to alter a rotational output of the motor 100. For example, the modification mechanism may be configured to reverse, pause or interrupt, or reciprocate the rotational output of the motor 100. For example, the modification mechanism may be an impact driver mechanism.

The drive transmission 300 may include one or more translation mechanisms to translate the rotational output of the motor 100 to a linear motion. The linear motion may be reciprocal. For example, the translational mechanism may include a slider and crank, a rack and pinion, a camming mechanism e.g. a hammer and anvil arrangement.

The drive transmission 300 is arranged to drive the working output 200 to operate in one of a plurality of operation modes. In each of the operating modes the drive transmission 300 may be configured to vary any of the speed, rotational direction, linear travel and/or direction of the motor 100.

The plurality of operation modes may include at least one of an impacting mode, a drilling mode and a hammer drill mode. The impacting mode may allow the working output 200 to reciprocate along a central axis of the working output 200. The drilling mode may allow the working output 200 to rotate about a central axis of the working output 200. The hammer drill mode may allow the working output 200 to perform both reciprocating and rotary actions simultaneously.

The mode change switch 500 is configured to switch the drive transmission 300 between the at least two operation modes. The mode change switch 500 may include a rotary or linear slide selector, e.g. rotary/linear potentiometer, or a Hall effect sensor and magnet arrangement. The mode change switch 500 may include an arrangement of one or more push buttons, or any other user interface selector element, including soft elements (e.g., a touch screen).

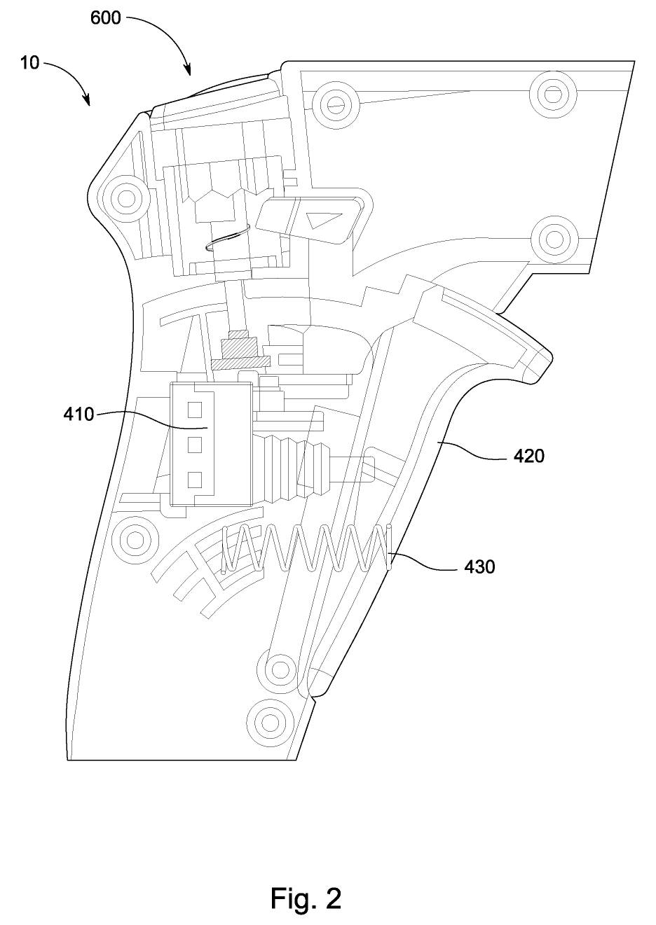

FIG. 2 shows a partial section view of a power tool 1 according to an embodiment. The power tool 1 may include a trigger module 10. The trigger module 10 may be arranged within a trigger housing which may be wholly or partially separated from a main housing, e.g., a motor housing, of the power tool 1. Alternatively, the trigger module 10 may be arranged within the main housing. As shown, the trigger module 10 may include the main trigger 400 and/or the lock-on switch 600. The trigger module 10 may also include the mode change switch 500 and/or the control unit 700.

The main trigger 400 may include a signal switch 410 and an actuator 420. The actuator 420 may be configured to move from an inactive position to an active position when actuated by a user. A spring 430 biases the actuator 420 in the inactive position. The spring 430 may be a compression spring. The actuator 420 may be arranged to activate the signal switch 410 in the active position. The signal switch 410 may include at least one of an electrical contact switch, a microswitch, a Hall effect switch and a linear or rotary potentiometer. The main trigger 400 may be configured to output a binary on/off signal. Alternatively, the main trigger 400 may be configured to output a variable signal value ranging from a minimum to a maximum value according to the actuator 420 position. The actuator 420 may be a lever that is rotatably or slidably mounted.

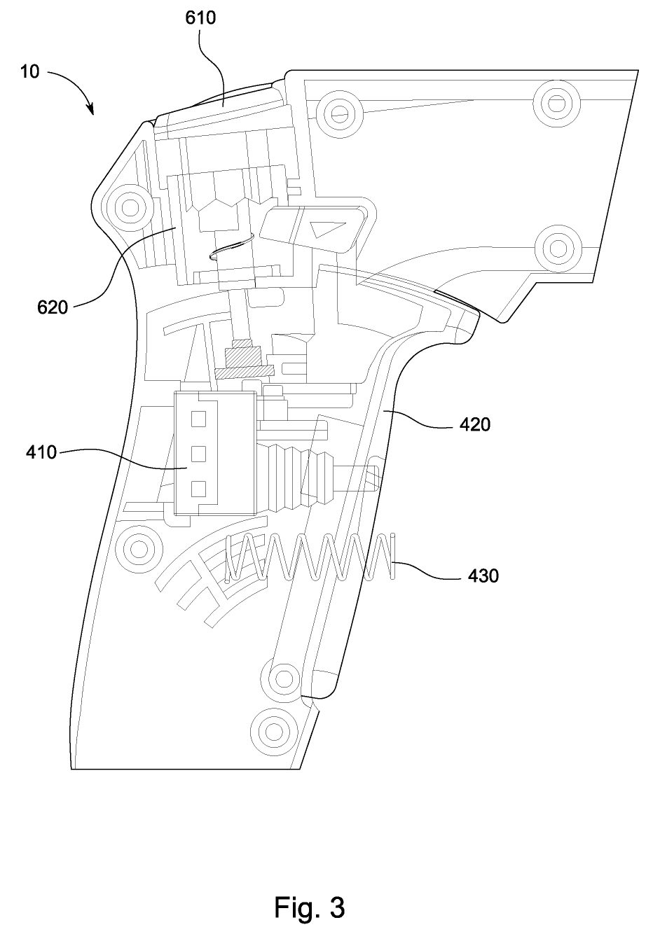

FIG. 3 shows a partial section view of a power tool 1 according to an embodiment. As shown, the main trigger 400 may be moved from the inactive position of FIG. 2 to an active position. In the active position, the signal switch 410 may be activated by the actuator 420. The main trigger 400 may include a trigger spring to bias the actuator 420 to the inactive position.

The lock-on switch 600 is configured to move between an active status position and an inactivate status position. The lock-on switch 600 may include at least one of an electrical contact switch, a microswitch, a Hall effect switch and a linear or rotary potentiometer. A control mechanism of the lock-on switch 600 may include at least one of a push-and-hold control, a push-on/push-off control, a rotary control, and a slide control. The lock-on switch 600 may include any of a lock button 610, a guide body 620, and a tactile switch 630. The lock button 610 may be arranged to be depressed by a user. The guide body 620 may be formed with a through opening. The lock button 610 may be arranged to slide within the guide body 620. The lock button 610 may be configured to move from a first position to a second position. The lock button 610 may be arranged to activate the tactile switch 630 in the second position. The tactile switch 630 may be configured to output a lock-on signal when activated.

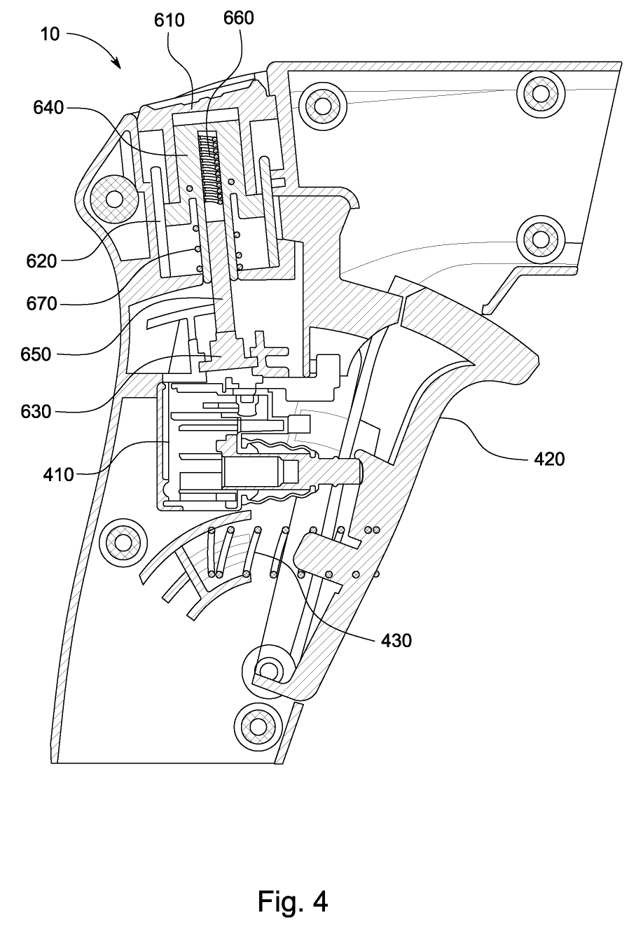

FIG. 4 shows a partial section view of a power tool 1 according to an embodiment.

The lock-on switch 600 may include any of a lock body 640, a press pin 650, a press spring 660, and a reset spring 670. When the lock button 610 is pressed, the lock button 610 may push the lock body 640 downwards. The guide body 620 may include one or more internal threads configured to engage with the locking body. The guide body 620 may be configured to rotate the lock body 640 as it slides downwards. The lock body 640 may be rotated from a released position to an engaged position. The lock body 640 may urge the press pin 650 to activate the tactile switch 630 as the lock body 640 slides downwards.

When the lock button 610 is the second position the reset spring 670 may be compressed. The reset spring 670 may be arranged to push the lock body 640 upwards. The guide body 620 may be configured to block upwards movement of the lock body 640 when the lock body 640 is in the engaged position. When the lock button 610 is released, the lock body 640 may remain substantially stationary, and the tactile switch 630 may remain activated. The press spring 660 may be arranged between the lock button 610 and the lock body 640. When the lock button 610 is released, the lock body 640 may remain substantially stationary, and the press spring 660 may push the lock button 610 to the first position.

If the lock button 610 is pressed a second time, the lock button 610 may engage with the lock body 640 and push the lock body 640 a small distance downwards. The internal threads of guide body 620 may be configured to rotate the lock body 640 further as it slides downwards. The lock body 640 may be rotated from the engaged position to the released position. When the lock button 610 is released, the reset spring 670 may push the lock body 640 and the lock button 610 the first position. The press pin 650 may release the tactile switch 630.

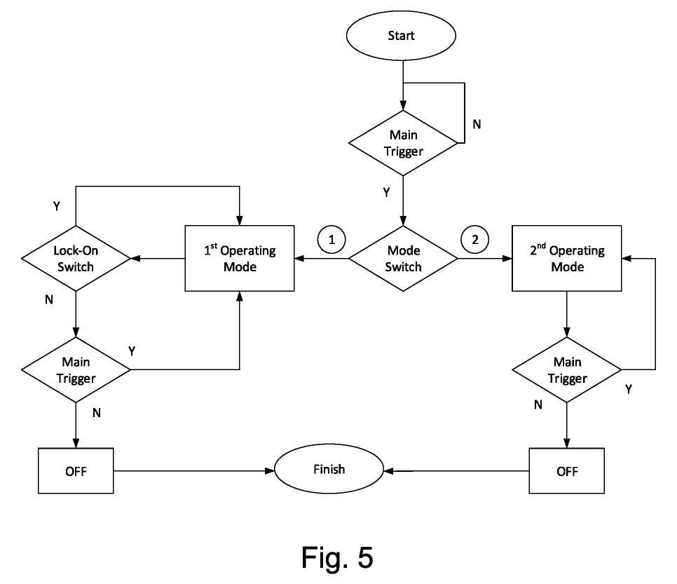

FIG. 5 shows an exemplary process of operating a power tool 1 according to an embodiment.

The control unit 700 is configured to detect an actuation status of a main trigger 400 of the power tool 1. In response to detecting that the actuation status of the main trigger 400 is turned off, the control unit 700 may be configured to monitor the actuation status of the main trigger 400.

In response to detecting that the actuation status of the main trigger 400 is turned on, the control unit 700 is configured to operate the power tool 1 in one of at least two operation modes. The control unit 700 is configured to detect the current operation mode. The control unit 700 may be configured to determine a status of the mode change switch 500.

In some examples, the first mode may be the impacting mode and the second operation mode may be the drilling mode. In some examples, the first mode may be the impacting mode and the second operation mode may be the hammer drill mode.

In response to detecting the first operation mode, the control unit 700 is configured to operate the power tool 1 in the first operation mode. The control unit 700 is configured to detect the status of a lock-on switch 600 of the power tool 1. If the status of the lock-on switch 600 is active, the control unit 700 may be configured to continue the first operation mode. The control unit 700 may be configured to monitor the status of the lock-on switch 600.

If the status of the lock-on switch 600 is inactive, the control unit 700 may be configured to detect the actuation status of the main trigger 400. If the actuation status of the main trigger 400 is on, the control unit 700 may be configured to continue the first operation mode. The control unit 700 may be configured to monitor the status of the lock-on switch 600 and the actuation status of the main trigger 400.

If the status of the lock-on switch 600 is inactive and the actuation status of the main trigger 400 is turned off, the control unit 700 is configured to turn off the motor 100.

In response to detecting the second operation mode, the control unit 700 is configured to operate the power tool 1 in the second operation mode. The control unit 700 may be configured to detect the actuation status of the main trigger 400. If the actuation status of the main trigger 400 is on, the control unit 700 may be configured to continue the second operation mode. The control unit 700 may be configured to monitor the actuation status of the main trigger 400.

If the actuation status of the main trigger 400 is turned off, the control unit 700 is configured to turn off the motor 100. In response to detecting a second operation mode, the control unit 700 is configured to operate the power tool 1 in the second operation mode until the actuation status of the main trigger 400 is turned off, regardless of the detected status of the lock-on switch 600.

In this way, the lock-on status of the power tool 1 can be applied in one operational mode, but not activated in another operational mode where it is not appropriate to lock the tool. For example, the second operational mode may be a hammer drill mode, where it might be unsafe to have apply a lock-on function. Therefore, the power tool 1 according to an embodiment can prevent the lock-on mode from being activated in the hammer drill mode. Control of the tool in the second operational mode can be effected solely based on the main trigger 400, regardless of the lock-on switch 600 status. This functionality is not possible with a purely mechanical lock-on assembly.

The lock-on switch 600 may be coupled with a mechanical locking element such that moving the lock-on switch 600 to the active status position causes the mechanical locking element to move into a blocking position configured to hold the main trigger 400 in a turned-on actuation status. This can provide the user with visual and tactile feedback that the lock-on mode is activated, by seeing and feeling the retracted main trigger 400.

The control unit 700 may be configured to, in response to a second operation mode, deactivate the power tool 1 in response to detecting an active status of the lock-on switch 600. In this way, the lock-on mode may be prevented from activating during the second operational mode. When the main trigger 400 is mechanically locked in place by the lock-on switch 600, the power tool 1 can be deactivated to prevent unsafe operation.

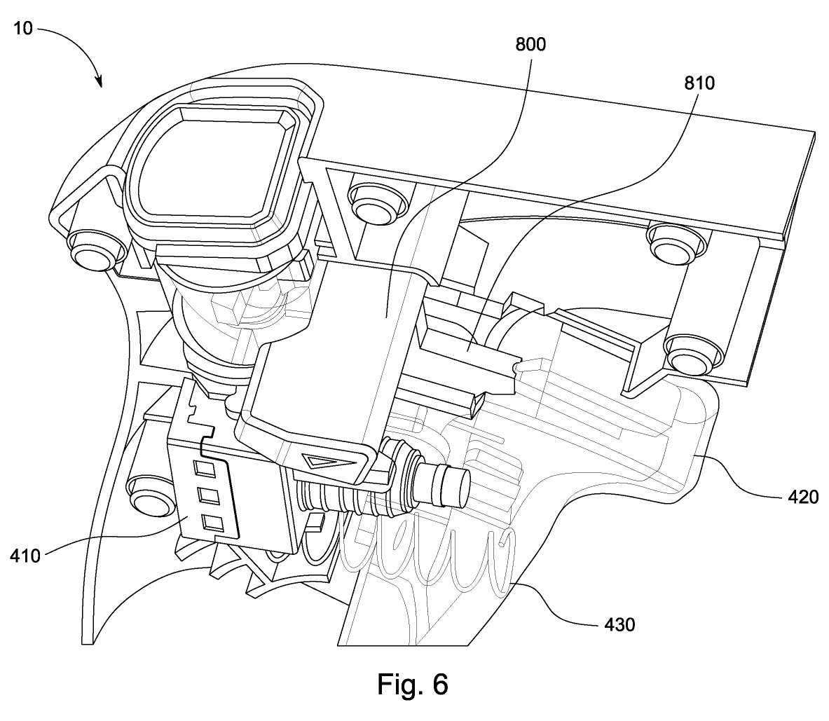

FIG. 6 shows a partial section view of a power tool 1 according to an embodiment. The trigger module 10 may include a forward/reverse (F/R) switch 800. The F/R switch 800 may transmit an F/R control signal to the control unit 700. The control unit 700 may be configured to control the motor 100 and/or drive transmission 300 to rotate in a forward or reverse direction, according to the position of the F/R switch 800. The F/R switch 800 may be a linear sliding or rotary switch. The F/R switch 800 may have two positions, a first position for a forward direction and a second position for a reverse direction.

The F/R switch 800 may have third position, which may be neutral position. In the neutral position a neutral control signal or no control signal may be sent to the control unit 700. The control unit 700 may be configured to not active the motor 100 when the F/R switch 800 is in the neutral position. The F/R switch 800 may include a lock-off element 810. The lock-off element 810 may be arranged to abut with the main trigger 400 when the F/R switch 800 is in the neutral position. The lock-off element 810 may be arranged to prevent movement of the main trigger 400 in an actuation direction. In this way, the lock-off element 810 can provide an additional physical barrier to activation of the tool. In the first position and the second position the lock-off element 810 may be arranged to allow movement of the main trigger 400. In addition, the interaction between the lock-off element 810 and the main trigger 400 may prevent the F/R switch 800 from being returned to the neutral position when in either of the first position and the second position. This can prevent damage to the motor 100 and/or drive transmission 300 by prevent direction changes when the motor 100 is activated.

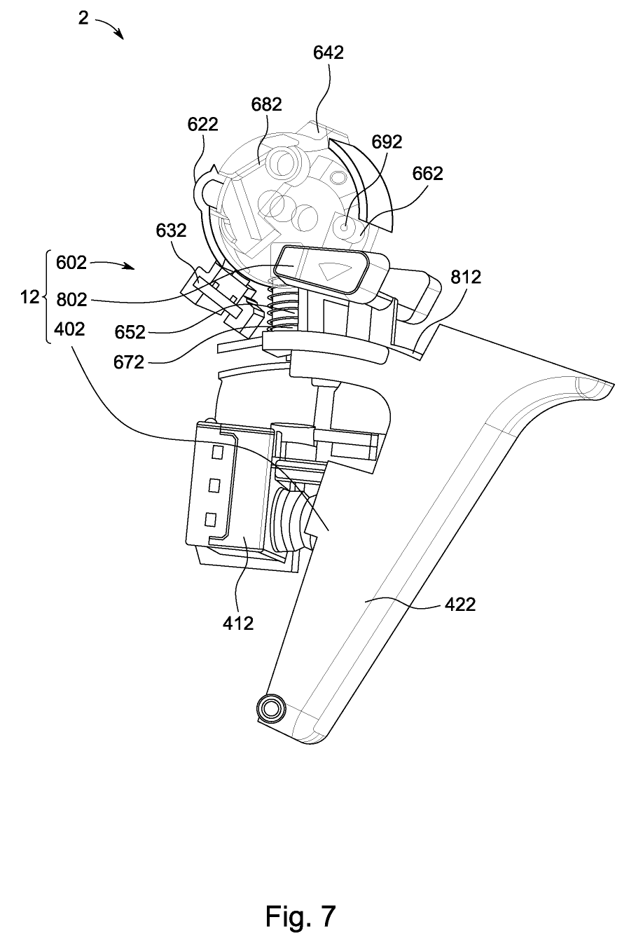

FIG. 7 shows a partial section view of a power tool 2 according to a second embodiment. Elements not described in detail are substantially as described with respect to the first embodiment. The power tool 2 may include a trigger module 12. As shown, the trigger module 12 may include any of the main trigger 402, the lock-on switch 602, and F/R switch 802.

The main trigger 402 may include a signal switch 412 and an actuator 422. The F/R switch 802 may include a lock-off element 812. The lock-off element 812 may be arranged to abut with the main trigger 402 when the F/R switch 802 is in the neutral position. The lock-off element 812 may be arranged to prevent movement of the main trigger 402 in an actuation direction. In the first position and the second position the lock-off element 812 may be arranged to allow movement of the main trigger 402. The main trigger 402 may be arranged to prevent the F/R switch 802 from being returned to the neutral position when in either of the first position and the second position.

The lock-on switch 602 may include any of a lock body 642, a lock housing 622, a locking pin 652, a locking spring 682, a tactile switch 632, a reset spring 672, a locating pin 692, and a retaining spring 662. The lock body 642 may be rotatably mounted within the lock housing 622. As shown, the lock-on switch 602 may be in an unlocked position, where the lock body 642 is rotated to a clockwise position.

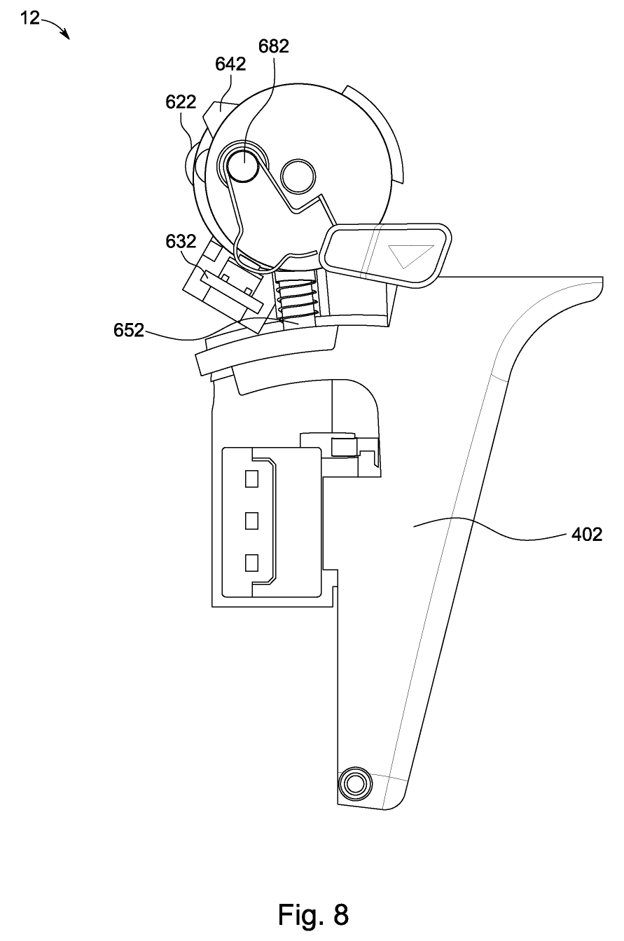

FIG. 8 shows a partial section view of a power tool 2 according to a second embodiment. As shown, the lock-on switch 602 may be in a locked position, where the lock body 642 is rotated to a counterclockwise position. The lock-on switch 602 may be moved to the locked position with the main trigger 402 in the actuated position. The lock-on switch 602 may be configured to push the locking pin 652 down from a released position to an engaged position. In the engaged position, the locking pin 652 may engage with the main trigger 402 and prevent movement of the main trigger 402. The main trigger 402 may be locked in the actuated position.

The locking spring 682 may be a flat spring, leaf spring, or coil spring. In the locked position, the locking spring 682 may be configured to extend out of the lock body 642 and press the tactile switch 632. The locking spring 682 may be retained from extending further by the lock housing 622. The retaining spring 662 may be arranged to push the locating pin 692 into the lock housing 622.

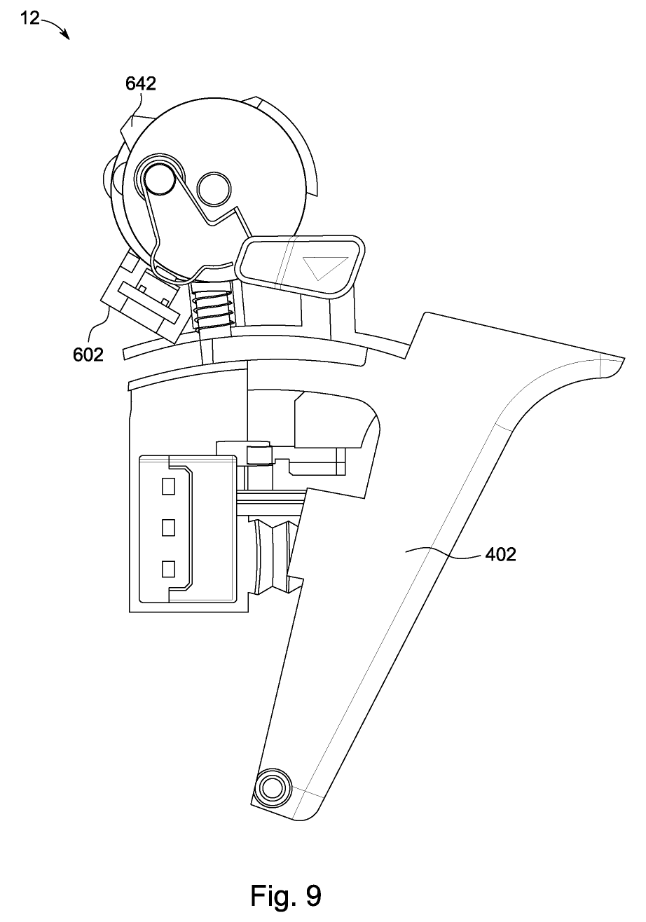

FIG. 9 shows a partial section view of a power tool 2 according to a second embodiment. The lock-on switch 602 may be moved to the locked position with the main trigger 402 in the released position. The main trigger 402 may be locked in the released position.

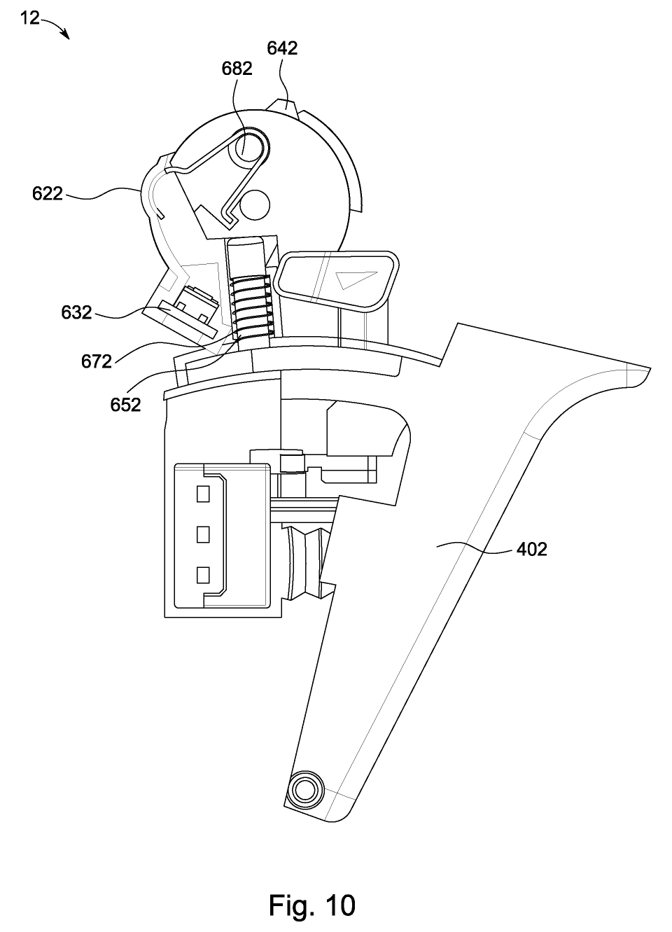

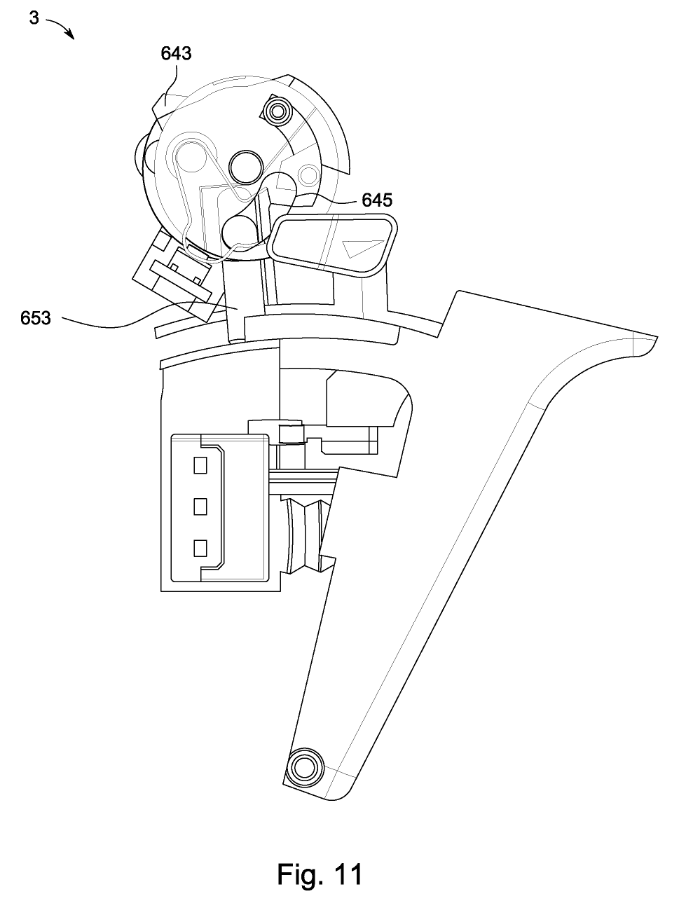

FIG. 10 shows a partial section view of a power tool 2 according to a second embodiment. The lock-on switch 602 may be moved clockwise to the unlocked position. The reset spring 672 may be arranged to push the locking pin 652 to the released position. The locking pin 652 no longer locks the main trigger 402 in the unlocked position. The locking spring 682 may be pushed into the lock body 642 by the lock housing 622 as the lock body 642 rotated. In this way, the tactile switch 632 may be released. In the unlocked position, the lock housing 622 may be formed with a recess, such that the locking spring 682 can extend out of the lock body 642 into the recess. The retaining spring 662 may be arranged to push the locating pin 692 into the lock housing 622. FIG. 11 shows a partial section view of a power tool 3 according to a third embodiment. Elements not described in detail are substantially as described with respect to the second embodiment. Instead of a reset spring, the lock body 643 includes a guide groove 645. A radial position of the guide groove 645 with respect to a rotation axis of the lock body 643 is varied along the length of the guide groove 645. One end of the locking pin 653 may be fixed in the guide groove. As shown, the lock body 643 may be in the locked position, and the locking pin 653 may be arranged at a first end of the guide groove. At the first end of the guide groove, the locking pin 653 is held at the furthest distance from the rotation axis of the lock body 643. In this position, the locking pin 653 may be pushed into the engaged position, substantially as described above.

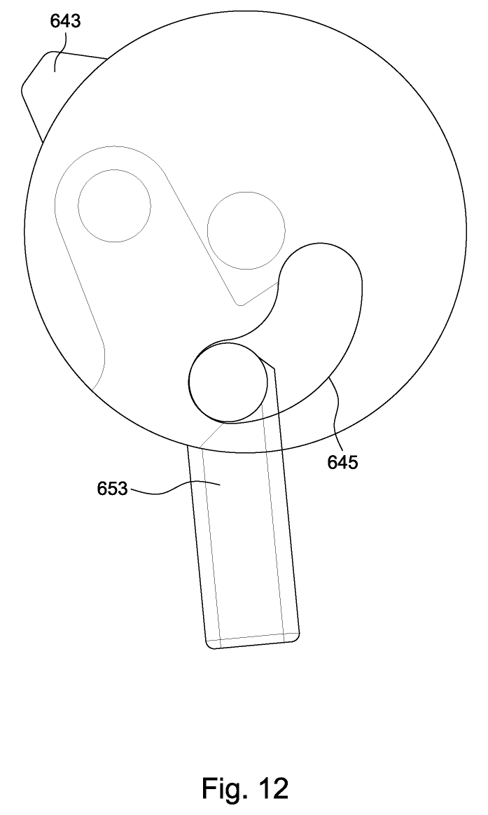

FIG. 12 shows a partial section view of a power tool 3 according to a third embodiment, showing additional detail of the lock body 643, guide groove 645 and locking pin 653 in the locked position. When the lock body 643 is rotated clockwise to the unlocked position, the locking pin 653 may be moved to the second end of the guide groove 645. In this position, the locking pin 653 may be pulled into the released position, substantially as described above.

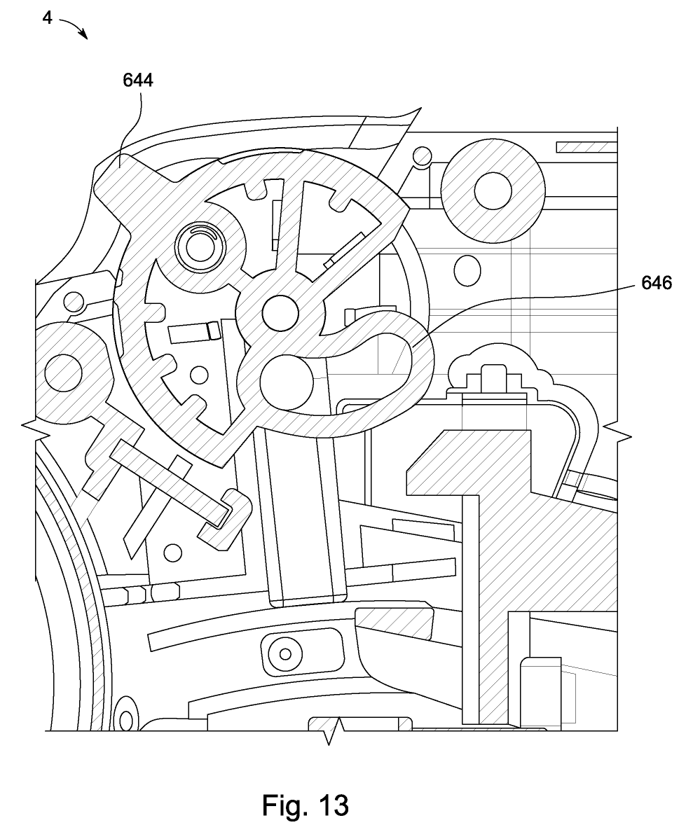

FIG. 13 shows a partial section view of a power tool 4 according to a fourth embodiment. As shown, the lock body 644 and guide groove 646 may be reversed from the third embodiment, such that the clockwise position is the locked position. The anticlockwise position may be the unlocked position.

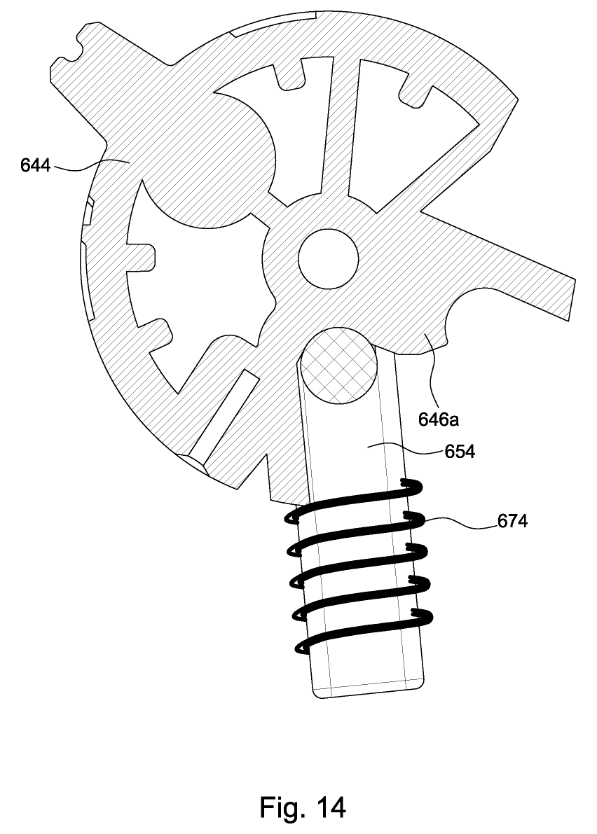

FIG. 14 shows a partial section view of a power tool 4 according to an alternative fourth embodiment, showing additional detail of the lock body 644, locking pin 654 and an alternative guide groove 646a. As shown, the anticlockwise position of the lock body 643 may be the unlocked position. The alternative guide groove 646a may be formed with an open profile, rather than surrounding an end portion of the locking pin 654. The reset spring 674 may be arranged to push the locking pin 654 to the released position. The alternative guide groove 646a may be formed with a detent profile, that is a protruding section compared with the smooth profile of the guide groove 646. The action of the reset spring 674 and the detent profile of the alternative guide groove 646a may combine to urge the lock body 644 towards the locked position or the unlocked position. The lock body can be prevented from coming to rest in any intermediate position between the locked position and the unlocked position. The profile of the alternative guide groove 646a may also be applied to the guide groove 645 of the third embodiment.

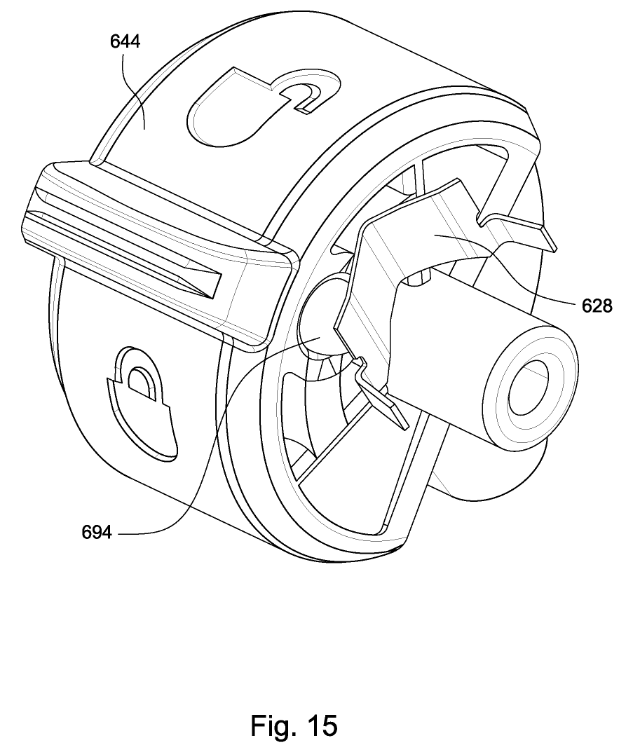

FIG. 15 shows an exposed view of the lock body 644 according to a fourth embodiment. The lock body 644 may include a ball detent 694 arranged to protrude from a side of the lock body 644. The ball detent 694 may be configured to engage with at least one detent recess 626 formed in the lock housing 624. For example, a first detent recess 626amay correspond to the locked position and a second detent recess 626b may correspond to the unlocked position. In this way, the lock body 644 can be allowed to rest only in the locked position or the unlocked position. The lock body 644 can be prevented from coming to rest in any intermediate position between the locked position and the unlocked position.

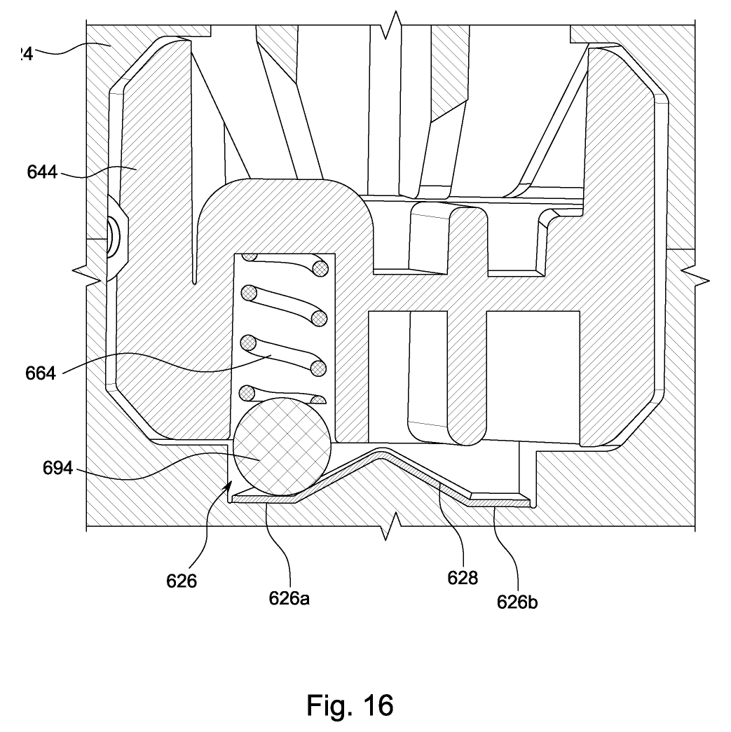

FIG. 16 shows a partial section view of the lock body 644 and the surrounding lock housing 624, according to a fourth embodiment. As shown, the lock body 644 may further comprise a detent spring 664. The detent spring 664 may be arranged to urge the ball detent 694 out of the lock body 644. In some examples, each of the detent recesses 626 may be formed as an opening or depression in an otherwise flat interior surface of the lock housing 624. In some examples, as shown, each of the detent recesses 626 may be formed as sloped portions of the interior surface of the lock housing 624. A slope apex may form a watershed between the first detent recess 626a and the second detent recess 626b. In some examples, each of the detent recesses 626 may be formed as a molding in the lock housing 624. Alternatively, or in addition, a rail stamping 628 may be formed to cover or form the shape of the first detent recess 626a and the second detent recess 626b. The rail stamping 628 may be formed of stamped metal.

The ball detent mechanism of the fourth embodiment may be combined with either of the second embodiment and the third embodiment.

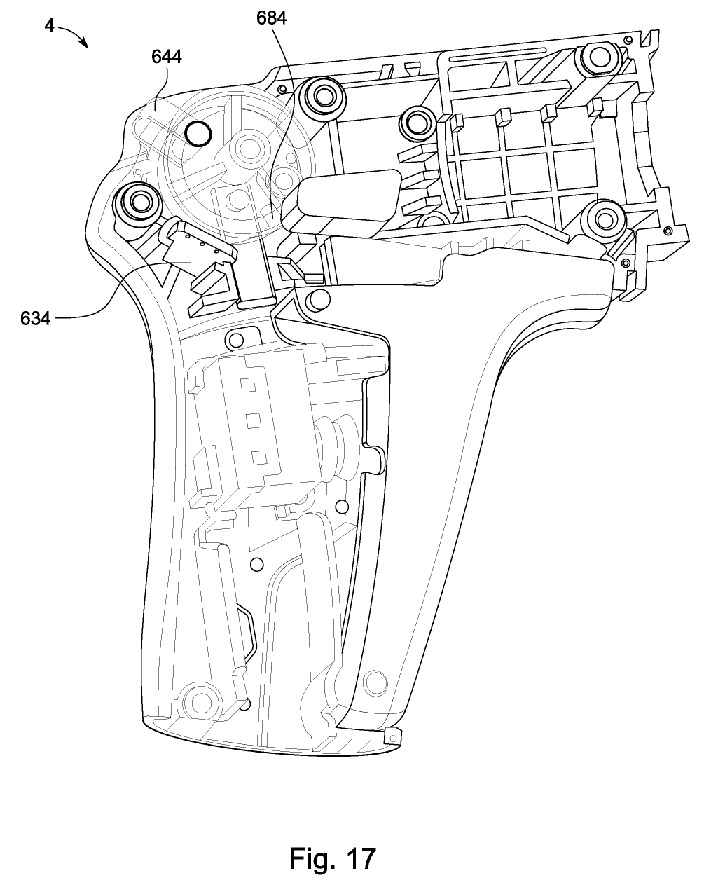

FIG. 17 shows a partial section view of a power tool 4 according to a fourth embodiment. As shown, the tactile switch may be replaced with a Hall sensor 634. The locking spring may be replaced with a magnet 684 mounted in the lock body 644. When the lock body 644 is in the unlocked counterclockwise position as shown, the magnet 684 may be positioned at a distance from the Hall sensor 634. When the lock body 644 is rotated to the locked clockwise position, the magnet 684 may be aligned with the Hall sensor 634. The Hall sensor 634 of the fourth embodiment may be combined with either of the second embodiment and the third embodiment.

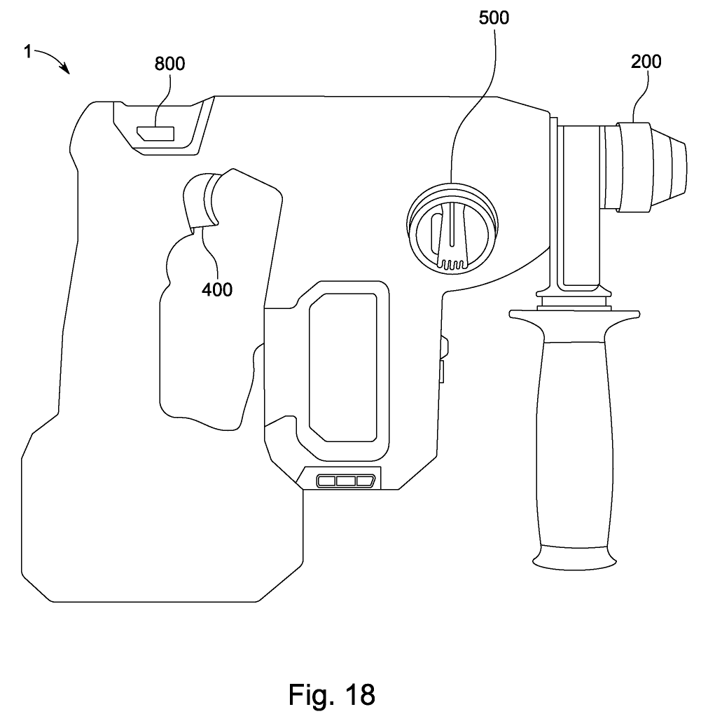

FIG. 18 shows an external view of a power tool 1 according to another embodiment. The power tool 1 may include at least one of a hammer drill, an impact driver, a drill driver, a chainsaw, a circular saw, a jigsaw and a blower. As shown, the power tool 1 may include a main housing, a trigger module 10, a main trigger 400, an F/R switch 800, a mode change switch 500 and a working output 200.

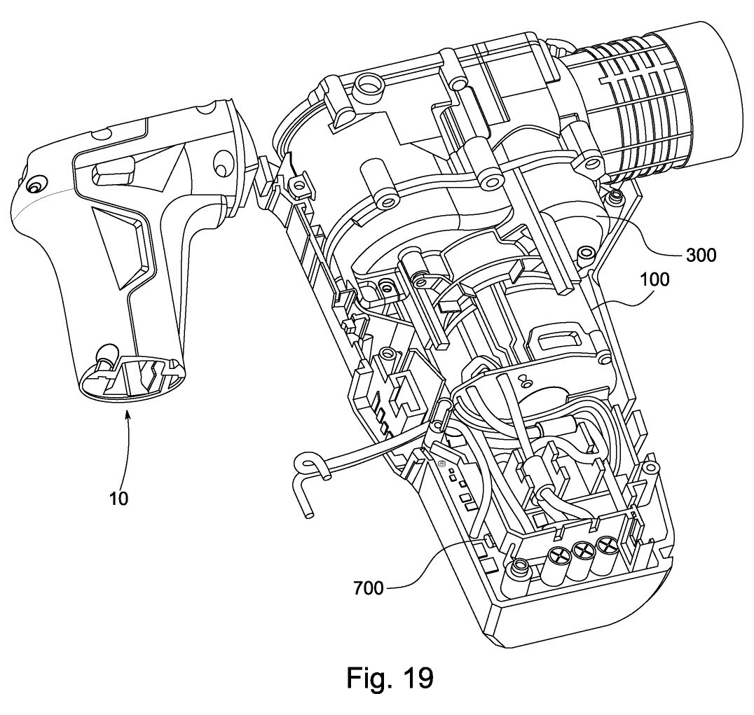

FIG. 19 shows a partial section view of a power tool 1 according to another embodiment. As shown, the trigger module 10 may be separate from a motor module or main housing. Alternatively, the trigger module 10 and motor module may be integrated into a single housing.

In some examples, as shown, the motor 100 may be arranged substantially vertically. The motor 100 may be substantially perpendicular to the working output 200. A control board of the power tool 1 may have the control unit 700 mounted thereon. The control board may be arranged below the motor 100. The control board may be arranged parallel to a vertical place bisecting the power tool 1 laterally. A heat sink may be mounted on or adjacent to the control board. The heat sink may include a plurality of fins protruding from a side facing away from the control board. The fins may be arranged to extend in a vertical direction. In this way, airflow into the housing and through the motor 100 may be maximized. The motor 100 may include a fan to increase airflow in a vertical direction through the housing. As shown, in FIG. 7, inlet air vents may be arranged adjacent to the control board heat sink and outlet air vents may be arranged adjacent to the motor 100.

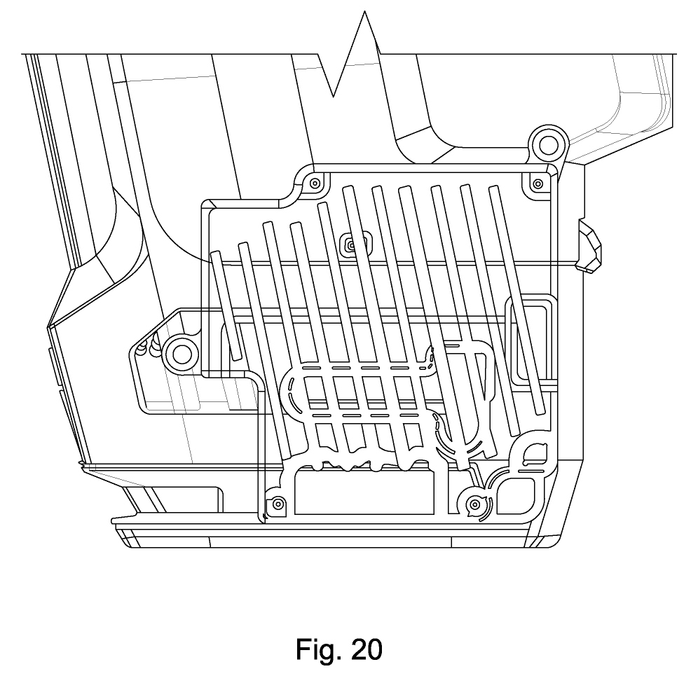

FIG. 20 shows a partial section view of a power tool 1 according to another embodiment. The inlet air vents may include a plurality of linear slots. The slots may be arranged to extend at an angle to the vertical. The fins may be arranged to extend in an angled direction. The fins may be arranged to extend in a direction parallel to the slots. In this way, air circulation through the fins may be improved.

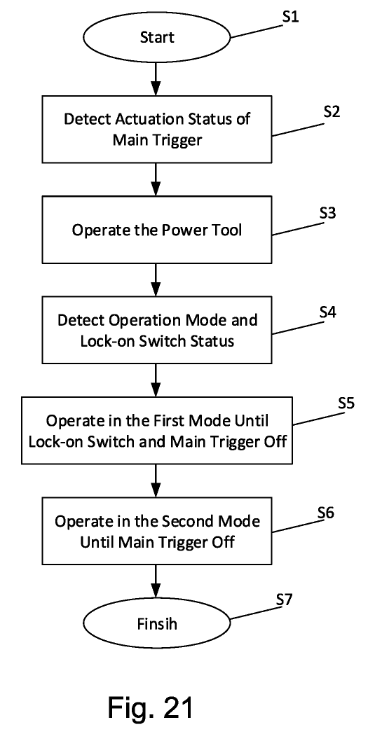

FIG. 21 shows a flowchart representing a method of operating a power tool according to an embodiment. The method starts at step S01.

At step S02, the actuation status of a main trigger of the power tool is detected.

At step S03, in response to detecting that the actuation status of the main trigger is turned on, the power tool is operated in one of at least two operation modes.

At step S04, the current operation mode and a status of a lock-on switch of the power tool are detected.

At step S05, in response to detecting a first operation mode and an active status of the lock-on switch, the power tool is operated in the first operation mode until the lock-on switch is turned off and the actuation status of the main trigger is turned off.

At step S06, in response to a second operation mode, regardless of the detected status of the lock-on switch, the power tool is operated in the second operation mode until the actuation status of the main trigger is turned off.

The method finishes at step S07.

The above embodiments are described by way of example only. Many variations are possible without departing from the scope of the disclosure as defined in the claims appended herein.

For clarity of explanation, in some instances the present technology may be presented as including individual functional blocks including functional blocks comprising devices, device components, steps or routines in a method embodied in software, or combinations of hardware and software.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, Universal Serial Bus (USB) devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the following claims.

What is claimed is:

1. A power tool comprising:
a motor;
a working output;
a drive transmission arranged to receive a power output of the motor and drive the working output to operate in one of a plurality of operation modes;
a main trigger;
a mode change switch configured to switch the drive transmission between the plurality of operation modes;
a lock-on switch configured to move between an active status position and an inactive status position; and
a control unit configured to:
detect an actuation status of the main trigger,
in response to detecting that the actuation status of the main trigger is turned on, operate the power tool in one of at least two operation modes,
detect the operation mode and a status of the lock-on switch,
in response to detecting a first operation mode and an active status of the lock-on switch, operate the power tool in the first operation mode until the status of the lock-on switch is inactive and the actuation status of the main trigger is turned off, and
in response to detecting a second operation mode, regardless of the detected status of the lock-on switch, operate the power tool in the second operation mode until the actuation status of the main trigger is turned off.

2. The power tool according to claim 1, wherein the plurality of operation modes includes at least one of an impacting mode, a drilling mode, or a hammer drill mode;
wherein the impacting mode allows the working output to reciprocate along a central axis of the working output;
wherein the drilling mode allows the working output to rotate about a central axis of the working output; and
wherein the hammer drill mode allows the working output to perform both reciprocating and rotary actions simultaneously.

3. The power tool according to claim 2, wherein the first operation mode is the impacting mode and the second operation mode is the drilling mode.

4. The power tool according to claim 2, wherein the first operation mode is the impacting mode and the second operation mode is the hammer drill mode.

5. The power tool according to claim 1, wherein the motor is a brushless DC motor.

6. The power tool according to claim 1, wherein the main trigger includes at least one of an electrical contact switch, a microswitch, a Hall effect switch, or a linear or rotary potentiometer.

7. The power tool according to claim 1, wherein the lock-on switch includes at least one of an electrical contact switch, a microswitch, a Hall effect switch, or a linear or rotary potentiometer.

8. The power tool according to claim 1, wherein a control mechanism of the lock-on switch includes at least one of a push-and-hold control, a push-on/push-off control, a rotary control, or a slide control.

9. The power tool according to claim 1, wherein the lock-on switch is coupled with a mechanical locking element such that moving the lock-on switch to the active status position causes the mechanical locking element to move into a blocking position to hold the main trigger in a turned-on actuation status, and wherein the control unit, in response to a second operation mode, is configured to deactivate the power tool in response to detecting an active status of the lock-on switch.

10. The power tool according to claim 1, wherein the power tool includes at least one of a hammer drill, an impact driver, a drill driver, a chainsaw, a circular saw, a jigsaw, or a blower.

11. A power tool comprising:
a motor;
a working output;
a drive transmission arranged to receive a power output of the motor and drive the working output to operate in one of a plurality of operation modes;
a main trigger;
a mode change switch configured to switch the drive transmission between the plurality of operation modes; and
a lock-on switch configured to move between an active status position and an inactive status position, the lock-on switch including
a lock housing,
a lock body disposed inside the lock housing and rotatable relative to the lock housing,
a locking pin selectively engageable with the main trigger,
a tactile switch, and
a locking spring configured to actuate the tactile switch,
wherein when the lock body is rotated to a first position, the locking pin is not engaged with the main trigger and the lock-on switch is in the inactive status position, and
wherein when the lock body is rotated to a second position, the locking pin is engaged with the main trigger and the lock-on switch is in the active status position.

12. The power tool according to claim 11, wherein when the lock body is rotated to the first position, the locking spring does not actuate the tactile switch.

13. The power tool according to claim 11, wherein when the lock body is rotated to the second position, the locking spring actuates the tactile switch.

14. The power tool according to claim 11, wherein the main trigger is configured to move between a released position and engaged position, and when the lock-on switch is in the active status position with the main trigger in the released position, the main trigger is locked in the released position.

15. The power tool according to claim 11, further comprising a control unit configured to detect a position of the lock-on switch, the main trigger, and the mode change switch.

16. A method of operating a power tool, the method comprising:
detecting an actuation status of a main trigger of the power tool;
in response to detecting that the actuation status of the main trigger is turned on, operating the power tool in one of at least two operation modes;
detecting a current operation mode and a status of a lock-on switch of the power tool;
in response to detecting a first operation mode and an active status of the lock-on switch, operating the power tool in the first operation mode until the lock-on switch is turned off and the actuation status of the main trigger is turned off; and
in response to switching to a second operation mode, regardless of the detected status of the lock-on switch, operating the power tool in the second operation mode until the actuation status of the main trigger is turned off.

17. The method according to claim 16, wherein the first and second operation modes include at least one of an impacting mode, a drilling mode, or a hammer drill mode;
wherein the impacting mode allows a working output to reciprocate along a central axis of the working output;
wherein the drilling mode allows the working output to rotate about a central axis of the working output; and
wherein the hammer drill mode allows the working output to perform both reciprocating and rotary actions simultaneously.

18. The method according to claim 17, wherein the first operation mode is the impacting mode and the second operation mode is the drilling mode.

19. The method according to claim 17, wherein the first operation mode is the impacting mode and the second operation mode is the hammer drill mode.

20. The method according to claim 16, further comprising, in response to switching to the second operation mode, deactivating the power tool in response to detecting an active status of the lock-on switch, wherein the lock-on switch is coupled with a mechanical locking element such that moving the lock-on switch to the active status causes the mechanical locking element to move into a blocking position configured to hold the main trigger in a turned-on actuation status.
